(19) United States
(12) Patent Application Publication
(10) Pub. No.: US 2010/0142520 A1
(43) Pub. Date: Jun. 10, 2010

(54) Mobile Communication Method and System Thereof

(75) Inventors: Chun-Teh Leu, Taipei (TW); Cheng-Kai Chen, Xizhi City (TW); Shih-Chang Kang, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: INSTITUTE FOR INFORMATION INDUSTRY, Taipei (TW)

(21) Appl. No.: 12/339,302

(22) Filed: Dec. 19, 2008

(30) Foreign Application Priority Data
Dec. 9, 2008 (TW) 97147892

(51) Int. Cl. H04L 12/50

(52) U.S. Cl. 370/357

(57) ABSTRACT

A mobile communication method for a mobile originating (MO) side communicating with a mobile terminating (MT) side is disclosed. A first media gateway (MGW) is included in the communication network serving the MO side, and a second MGW is included in the communication network serving the MT side. The mobile communication method includes: after a SETUP message is received from the mobile originating side, determining if the mobile originating side is in Circuit Switching (CS) Domain. If the MO side is under CS domain, determining if the MT side is under CS domain. When the MO side and the MT side are both under CS domain, voice communication signals between the MO side and the MT side are transmitted with CS bearer between the first MGW and the second MGW.

### RELATED APPLICATIONS

This application claims priority to Taiwan Application Serial Number 97147892, filed Dec. 9, 2008, which is herein incorporated by reference.

### BACKGROUND

1. Field of Invention

The present invention relates to a communication method and system thereof. More particularly, the present invention relates to a mobile communication method and system thereof.

2. Description of Related Art

Nowadays, a mobile communication system may be a Circuit Switching (CS) system or a Pack Switching (PS) system. A mobile communication device under CS domain uses CS bearer to transmit voice communication signals to a media gateway (MGW) of a service network serving the mobile communication device. When a mobile communication device is roaming under Internet Protocol (IP) Multimedia Subsystem (IMS) domain, the mobile communication device transmits voice communication signals using PS. In other words, the mobile communication device under IMS domain uses IMS bearer to transmit voice communication signals to a MGW of a service network for the mobile communication device.

In the prior art, voice communication signals between MGWs are transmitted with IMS bearer for communication capability between mobile communication devices in different domains (CS domain and IMS domain). Furthermore, a mobile communication device under IMS domain can only transmit or receive voice communication signals transmitted with IMS bearer. Therefore, a MGW serving the mobile communication device under IMS domain only forwards the voice communication signals with IMS bearer to other MGWs without conversion (IMS bearer to CS bearer or CS bearer to IMS bearer).

On the other hand, a mobile communication device under CS domain can only transmit or receive voice communication signals transmitted with CS bearer. Therefore, a media gateway serving the mobile communication device under CS domain may need to convert voice communication signals between CS bearer and IMS bearer. In addition, when a mobile communication device under CS domain communicates with another mobile communication device under CS domain, voice communication signals between these two mobile communication devices may be converted two times (CS bearer to IMS bearer and back to CS bearer) by the MGWs serving these two mobile communication devices, which wastes communication time and system resource of the service provider.

### SUMMARY

According to one embodiment of this invention, a mobile communication method for a mobile originating (MO) side communicating with a mobile terminating (MT) side is provided. An originating network serving the MO side has a first media gateway (MGW), and a visited network serving the MT side has a second MGW. The mobile communication method includes: after a setup message is received from the MO side, determining if the MO side is under Circuit Switching (CS) Domain. When the MO side is under CS domain, determining if the MT side is under CS domain. When the MO side and the MT side are both under CS domain, voice communication signals between the MO side and the MT side are transmitted with CS bearer between the first MGW and the second MGW.

According to another embodiment of this invention, a mobile communication system for a MO side communicating with a MT side is provided. The mobile communication system includes a first network serving the MO side and a second network serving the MT side. The first network includes a first access point (AP), a first Mobile Switching Center (MSC), a first MGW and a first Media Gateway Control Function (MGCF). The first AP establishes a connection with the MO side through Radio Access Network (RAN). The first MSC receives a first setup request from the MO side through the first AP. The first MGW includes a first CS module and a first IMS module. The first MGCF includes a determining module, a first message module and a first setting module. The determining module determines the MO side domain according to the first setup request. The first message module generates an invite message according to the first setup request and the MO side domain, wherein the domain field of the invite message is set according to the MO side domain. The first setting module configures the first MGW to use the first CS module or the first IMS module for communication. The second network includes a second AP, a second MSC, a second MGW and a second MGCF. The second AP establishes a connection with the MT side through RAN. The second MGW includes a second CS module and a second IMS module. The second MGCF includes a message-handling module, a second message module and a second setting module. The message-handling module receives the invite message from the first network, generates a second setup request according to the invite message, and makes the second MSC transmit the second setup request to the MT side through the second AP, such that a setup response is obtained from the MT side. The second message module generates a response message according to the MT side domain and transmitting the response message to the first MGCF, such that the first MGCF determines the MT side domain according to the response message. The second setting module configures the second MGW to use the second CS module or the second IMS module for communication. The first setting module and the second setting module configure the first MGW and the second MGW to use the first CS module and the second CS module respectively when the domain of the MO side and the domain of the MT side are both in CS domain, such that the voice communication signals between the MO side and the MT side are transmitted with CS bearer between the first MGW and the second MGW.

According to another embodiment of this invention, a storage medium is provided to store several instructions to execute a mobile communication method for a MO side communicating with a MT side. An originating network serving the MO side has a first MGW, and a visited network serving the MT side has a second MGW. The mobile communication method includes: after a setup message is received from the MO side, determining if the MO side is under CS domain. When the MO side is under CS domain, determining if the MT side is under CS domain. When the MO side and the MT side are both under CS domain, voice communication signals between the MO side and the MT side are transmitted with CS bearer between the first MGW and the second MGW.

These and other features, aspects, and advantages of the present invention will become better understood with reference to the following description and appended claims. It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a flow diagram of a mobile communication method 100 according to an embodiment of this invention;

FIG. 2 is a flow diagram of a mobile communication method 300 according to another embodiment of this invention; and

FIG. 3 is a block diagram of a mobile communication system according to another embodiment of this invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

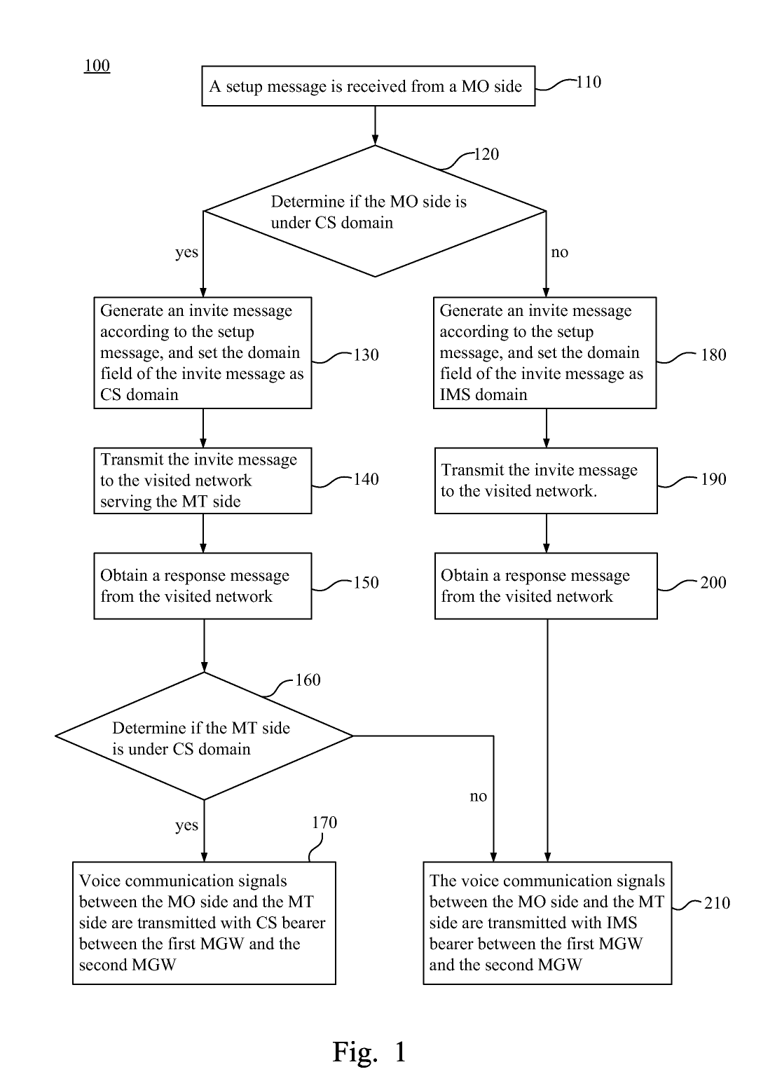

FIG. 1 is a flow diagram of a mobile communication method 100 according to an embodiment of this invention. When one mobile communication device wants to communicate with another mobile communication device, the mobile communication method 100 determine the transmitting bearer, used for transmitting voice communication signals generated by these two mobile communication devices between the media gateways serving these two mobile communication devices, according to the domain of these two mobile communication devices. Furthermore, the mobile communication method 100 may take the form of a computer program product on a computer-readable storage medium having computer-readable instructions embodied in the medium. Any suitable storage medium may be used including non-volatile memory such as read only memory (ROM), programmable read only memory (PROM), erasable programmable read only memory (EPROM), and electrically erasable programmable read only memory (EEPROM) devices; volatile memory such as SRAM, DRAM, and DDR-RAM; optical storage devices such as CD-ROMs and DVD-ROMs; and magnetic storage devices such as hard disk drives and floppy disk drives.

The mobile communication method 100 includes following steps:

In the step 110, a setup message is received from a mobile originating (MO) side, wherein the MO side, served by an originating network, wants to call a mobile terminating (MT) side, served by a terminating network, for communication. Then, determine if the MO side is under Circuit Switching (CS) domain (step 120). When the MO side is under CS domain, the setup message may follow the CS domain format, such as a SETUP message.

In the step 130, when the MO side is under CS domain, generate an invite message according to the setup message, and set the domain field of the invite message as CS domain, wherein the MO side invites the MT side for communication through the invite message. In the step 140, transmit the invite message to the visited network serving the MT side, such that obtaining a response message from the visited network (step 150). The invite message and the response message may follow Session Initiation Protocol (SIP). A new header field may be added to the invite message and the response message respectively to be the domain field of the invite message and the domain field of the response message, or existing field of the invite message may be defined respectively as the domain field of the invite message and the domain field of the response message.

In the step 160, determine if the MT side is under CS domain according to the domain field of the response message. If the domain field doesn't exist in the response message, which implies the visited network is not compatible with the mobile communication method 100, the MT side may be taken as not being under CS domain.

In the step 170, when the MO side and the MT side are both under CS domain, voice communication signals between the MO side and the MT side are transmitted with CS bearer between the first media gateway (MGW) of the originating network and the second MGW of the visited network. In addition, after the bearer used by the first MGW and the second MGW are set to CS bearer, the voice communication signals between the MO side and the MT side can start to be transmitted with CS bearer between the first MGW and the second MGW. When the MO side and the MT side are both under CS domain, the MO side and the MT side may only transmit or receive the voice communication signals transmitted with CS bearer. Hence, in the step 170, the first MGW and the second MGW only forward the voice communication signals without format conversion (CS bearer to IMS bearer or IMS bearer to CS bearer) between the first MGW and the second MGW, which saves the transmission time and system resources.

In the step 210, when the MT side is not under CS domain, the voice communication signals between the MO side and the MT side are transmitted with IMS bearer between the first MGW and the second MGW. After the bearer used by the first MGW and the second MGW are set to IMS bearer, the voice communication signals between the MO side and the MT side can start to be transmitted with IMS bearer between the first MGW and the second MGW.

In the step 180, when the mobile originating side is not under CS domain, generate an invite message according to the setup message, and set the domain field of the invite message as IMS domain. In the step 190, transmit the invite message to the visited network, such that obtaining a response message from the visited network (step 200). In the step 180 and step 190, the invite message and the response message may follow SIP.

Then, after the response message is obtained from the visited network (step 200), the voice communication signals between the MO side and the MT side are transmitted with IMS bearer between the first MGW and the second MGW (step 210). After the bearer used by the first MGW and the second MGW are set to IMS bearer, the voice communication signals between the MO side and the MT side can start to be transmitted with IMS bearer between the first MGW and the second MGW. When the MO side and the MT side are both under IMS domain, the MO side and the MT side may only transmit or receive the voice communication signals transmitted with IMS bearer. Therefore, when the MO side and the MT side are both under IMS domain, the first MGW and the second MGW only forward the voice communication signals between the first MGW and the second MGW without format conversion (IMS bearer to CS bearer or CS bearer to IMS bearer) in the step 210, which saves the transmission time and system resource.

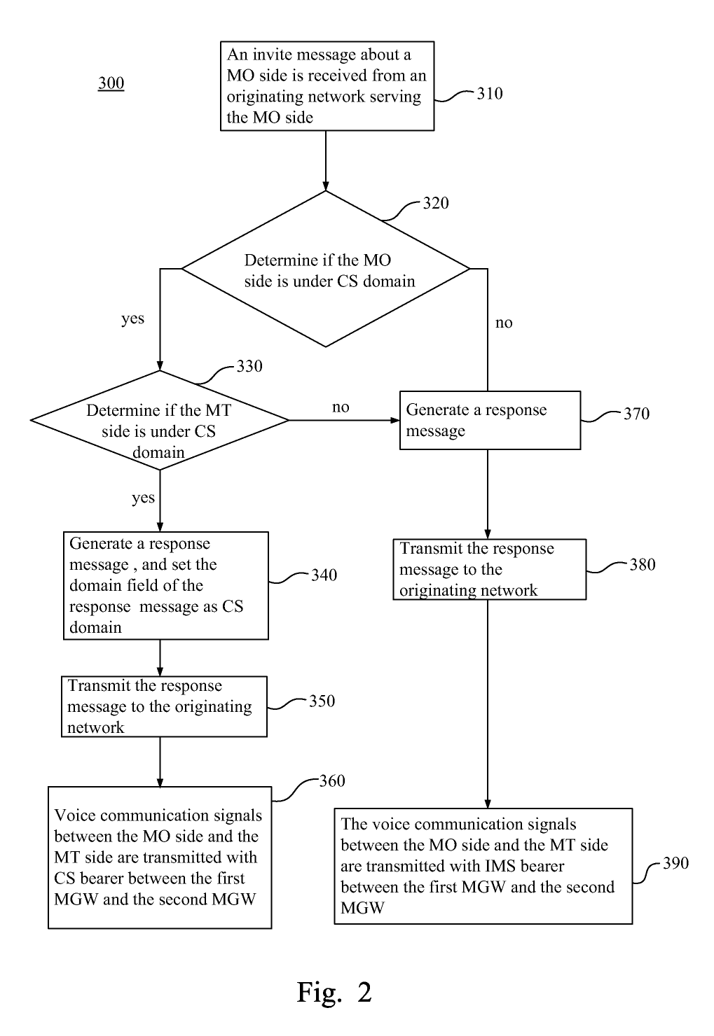

FIG. 2 is a flow diagram of a mobile communication method 300 according to another embodiment of this invention. When one mobile communication device wants to communicate with another mobile communication device, the mobile communication method 300 determine the bearer, used for transmitting voice communication signals generated by these two mobile communication devices between the media gateways serving these two mobile communication devices, according to the domain of these two mobile communication devices. Furthermore, the mobile communication method 300 may take the form of a computer program product on a computer-readable storage medium having computer-readable instructions embodied in the medium. Any suitable storage medium may be used including non-volatile memory such as ROM, PROM, EPROM, and EEPROM devices; volatile memory such as SRAM, DRAM, and DDR-RAM; optical storage devices such as CD-ROMs and DVD-ROMs; and magnetic storage devices such as hard disk drives and floppy disk drives.

The mobile communication method 300 includes the following steps:

In the step 310, an invite message about a MO side is received from an originating network serving the MO side, wherein the MO side, served by the originating network, invites a MT side, served by a visited network, for communication through the invite message. In the step 320, determine if the MO side is under CS domain according to the domain field of the invite message. A new header field may be added to the invite message to be the domain field of the invite message, or an existing field of the invite message may be defined as the domain field of the invite message.

When the MO side is under CS domain, determine if the MT side is under CS domain (step 330). In addition, when the MO side is under CS domain, generate and transmit a setup request to the MT side to obtain a setup response from the MT side. Then, determine if the MT side is under CS domain (step 330) according to the format of the setup response.

In the step 340, when the MT side is under CS domain, generate a response message, and set the domain field of the response message as CS domain. The response message may follow SIP. A new header field may be added to the response message to be the domain field of the response message, or an existing field of the response message may be defined as the domain field of the response message. In the step 350, transmit the response message to the originating network.

In the step 360, voice communication signals between the MO side and the MT side are transmitted with CS bearer between the first MGW of the originating network and the second MGW of the terminating network. In addition, after the bearer used by the first MGW and the second MGW are set to CS bearer, the voice communication signals between the MO side and the MT side can start to be transmitted with CS bearer between the first MGW and the second MGW. When the MO side and the MT side are both under CS domain, the MO side and the MT side may only transmit or receive the voice communication signals transmitted with CS bearer. Therefore, in the step 360, the first MGW and the second MGW only forward the voice communication signals between the first MGW and the second MGW, which saves the transmission time and system resource for not doing format conversion between CS bearer and IMS bearer.

When at least one of the MO side and the MT side is not under CS domain, generate a response message (step 370), and transmit the response message to the originating network (step 380). In addition, the domain field of the response message generated in the step 370 can be set to IMS domain or any other value except CS domain.

In the step 390, the voice communication signals between the MO side and the MT side are transmitted with IMS bearer between the first MGW and the second MGW

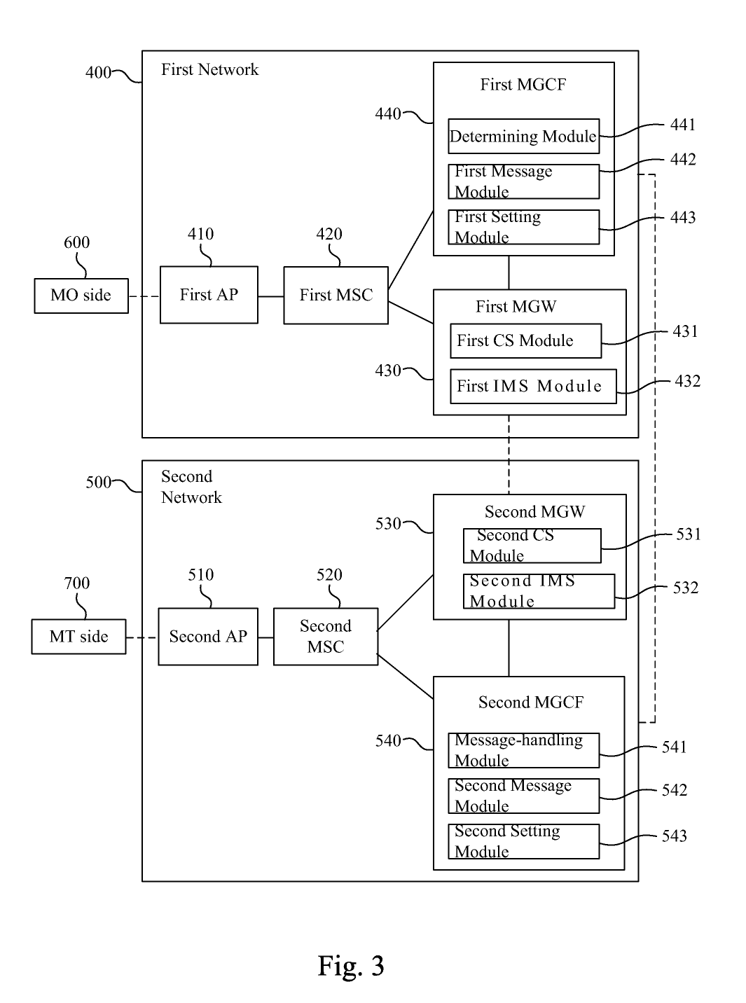

FIG. 3 is a block diagram of a mobile communication system according to another embodiment of this invention. When one mobile communication device wants to communicate with another mobile communication device, the mobile communication system determine the bearer, used for transmitting voice communication signals generated by these two mobile communication devices between the media gateways serving these two mobile communication devices, according to the domain of these two mobile communication devices. The mobile communication system includes a first network 400 and a second network 500. The first network 400 serves for a MO side 600. The second network 500 serves for a MT side 700, which the MO side 600 wants to communicate with.

The first network 400 includes a first Access Point (AP) 410, a first Mobile Switching Center (MSC) 420, a first MGW 430 and a first media gateway control function (MGCF) 440. The first MGW 430 includes a first CS module 431 and a first IMS module 432. The first MGCF 440 includes a determining module 441, a first message module 442 and a first setting module 443. The second network 500 includes a second AP 510, a second MSC 520, a second MGW 530 and a second MGCF 540. The second MGW 530 includes a second CS module 531 and a second IMS module 532. The second MGCF 540 includes a message-handling module 541, a second message module 542 and a second setting module 543.

The first AP 410 establishes a connection with the MO side 600 through Radio Access Network (RAN). The first MSC 420 receives a first setup request from the MO side 600 through the first AP 410. The determining module 441 obtains domain of the MO side 600 according to the first setup request. When the MO side 600 is under CS domain, the first setup request may follow the CS domain format, such as a SETUP message. The first message module 442 generates an invite message according to the first setup request and the domain of the MO side 600, and transmits the invite message to the second network 500 serving the MT side 700. The invite message may follow SIP. A new header field may be added to the invite message to be the domain field of the invite message, or an existing field of the invite message may be defined as the domain field of the invite message. The first setting module 443 sets the first MGW 430 to use the first CS module 431 or the first IMS module 432 for communication. The first setting module 443 uses H.248 and Q.1950 to configure the first MGW 430. The first MGW 430 uses the first CS module 431 to transmit voice communication signals to other MGWs utilizing CS bearer; the first MGW 430 uses the first IMS module 432 to transmit voice communication signals to other MGWs utilizing IMS bearer.

The second AP 510 establishes a connection with the MT side through RAN. After the invite message is received, the message-handling module 541 generates a second setup request according to the invite message, and makes the second MSC 520 transmit the second setup request to the MT side 700 through the second AP 510, such that a setup request is obtained from the MT side 700. The second message module 542 generates a response message according to domain of the MT side 700 and transmitting the response message to the first MGCF 440, such that the first MGCF 440 determines the domain of the MT side 700 according to the response message. In other words, the second message module 542 sets the domain field of the response message according to the domain of the MT side 700. The response message may follow SIP. A new header field may be added to the response message to be the domain field of the response message, or an existing field of the response message may be defined as the domain field of the response message. The second setting module 543 sets the second MGW 530 to use the second CS module 531 or the second IMS module 532 for communication. The second setting module 543 sets the second media gateway 530 utilizing H.248 and Q.1950. The second MGW 530 uses the second CS module 531 to transmit voice communication signals to other MGWs utilizing CS bearer; the second MGW 530 uses the second IMS module 532 to transmit voice communication signals to other MGWs utilizing IMS bearer.

When the domain of the MO side 600 and the domain of the MT side 700 are both in CS domain, the first setting module 443 sets the first MGW 430 to use the first CS module 431 for communication, and the second setting module 543 sets the second MGW 530 to use the second CS module 531 for communication. Therefore, voice communication signals between the MO side 600 and the MT side 700 are transmitted with CS bearer between the first MGW 430 and the second MGW 530. When the MO side 600 is under CS domain, voice communication signals generated by the MO side 600 may be transmitted with CS bearer. In addition, when the MT side 700 is under CS domain, voice communication signals generated by the MT side 700 may be transmitted with CS bearer. Therefore, when the MO side 600 and the MT side 700 are both under CS domain, the first CS module 431 and the second CS module 531 may just forward voice communication signals generated by the MO side 600 and the MT side 700, which makes voice communication signals between the MO side 600 and the MT side 700 transmitted with CS bearer between the first MGW 430 and the second MGW 530.

When at least one of the domain of the MO side 600 and the domain of the MT side 700 is not in CS domain, the first setting module 443 sets the first MGW 430 to use the first IMS module 432 for communication, and the second setting module 543 sets the second MGW 530 to use the second IMS module 532 for communication. Therefore, voice communication signals between the MO side 600 and the MT side 700 are transmitted with IMS bearer between the first media gateway 430 and the second media gateway 530.

Several different advantages exist with these and other embodiments. When the MO side and the MT side are both under CS domain, voice communication signals generated by the MO side and the MT side are only forwarded between the media gateways serving the MO side and the MT side, which saves the transmission time and system resource for bearer format conversion. In addition, when the MO side or the MT side is under IMS domain, the MO side can still communicate with the MT side by utilizing IMS bearer to transmit voice communication signals between the media gateways serving the MO side and the MT side.

Although the present invention has been described in considerable detail with reference to certain embodiments thereof, other embodiments are possible. Therefore, their spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A mobile communication method for a mobile originating (MO) side communicating with a mobile terminating (MT) side, wherein an originating network serving the MO side has a first Media Gateway (MGW), a visited network serving the MT side has a second MGW, and the mobile communication method comprises:
after a setup message is received from the MO side, determining if the MO side is in Circuit Switching (CS) Domain;
when the MO side is under CS domain, determining if the MT side is under CS domain; and
when the MO side and the MT side are both under CS domain, voice communication signals between the MO side and the MT side are transmitted with CS bearer between the first MGW and the second MGW.

2. The mobile communication method of claim 1, further comprising:
when the MO side is not under CS domain, the voice communication signals between the MO side and the MT side are transmitted with Internet Protocol (IP) Multimedia Subsystem (IMS) bearer between the first MGW and the second MGW.

3. The mobile communication method of claim 1, further comprising:
when the MT side is not under CS domain, the voice communication signals between the MO side and the MT side are transmitted with IMS bearer between the first MGW and the second MGW.

4. The mobile communication method of claim 1, wherein the step of determining if the MT side is under CS domain comprises:
generating an invite message according to the setup request, and setting the domain field of the invite message as CS domain;
transmitting the invite message to the visited network, such that an response message is obtained from the visited network; and
determining if the MT side is under CS domain according to the domain field of the response message.

5. The mobile communication method of claim 4, wherein the invite message and the response message follow Session Initiation Protocol (SIP).

6. The mobile communication method of claim 1, wherein the step of determining if the MO side is under CS domain comprises:
receiving an invite message about the MO side from the originating network; and
determining if the MO side is under CS domain according to the domain field of the invite message.

7. The mobile communication method of claim 6, wherein the step of determining if the MT side is under CS domain comprises:
generating and transmitting a setup request to the MT side to obtain a setup response from the MT side; and
determining if the MT side is under CS domain according to the setup response.

8. A mobile communication system for a mobile originating (MO) side to communicate with a mobile terminating (MT) side, comprising:
a first network for serving the MO side, comprising:
a first Access Point (AP) for building connection with the MO side through Radio Access Network (RAN);
a first Mobile Switching Center (MSC) for receiving a first setup request from the MO side through the first AP;
a first media gateway (MGW), comprising:
a first Circuit Switching (CS) module; and
a first Internet Protocol (IP) Multimedia Subsystem (IMS) module; and
a first Media Gateway Control Function (MGCF), comprising:
a determining module for determining domain of the MO side according to the first setup request;
a first message module for generating an invite message according to the first setup request and the domain of the MO side, wherein the domain of the MO side is set in the domain field of the invite message; and
a first setting module for setting the first MGW to use the first CS module or the first IMS module for communication; and
a second network for serving the MT side, comprising:
a second AP for building connection with the MT side through RAN;
a second MSC;
a second MGW, comprising:
a second CS module; and
a second IMS module; and
a second MGCF, comprising:
a message-handling module for receiving the invite message from the first network, generating a second setup request according to the invite message, and making the second MSC transmit the second setup request to the MT side through the second AP, such that a setup response is obtained from the MT side;
a second message module for generating a response message according to domain of the MT side and transmitting the response message to the first MGCF, such that the first MGCF determines the domain of the MT side according to the response message; and
a second setting module for setting the second MGW to use the second CS module or the second IMS module for communication;
wherein the first setting module and the second setting module set the first MGW and the second MGW to use the first CS module and the second CS module respectively when the domain of the MO side and the domain of the MT side are both in CS domain, such that voice communication signals between the MO side and the MT side are transmitted with CS bearer between the first MGW and the second MGW.

9. The mobile communication system of claim 8, wherein the first setting module uses H.248 and Q.1950 to configure the first MGW, and the second setting module uses H.248 and Q.1950 to configure the second MGW.

10. The mobile communication system of claim 8, wherein the invite message and the response message both follow SIP.

11. A storage medium to store several instructions to execute a mobile communication method for a mobile originating (MO) side communicating with a mobile terminating (MT) side, wherein an originating network serving the MO side has a first MGW, a visited network of the MT side has a second MGW, and the mobile communication method comprises:
after a setup message received from the MO side, determining if the MO side is under CS domain;
when the MO side is under CS domain, determining if the MT side is under CS domain; and
when the MO side and the MT side are both under CS domain, voice communication signals between the MO side and the MT side are transmitted with CS bearer between the first MGW and the second MGW.

12. The storage medium of claim 11, further comprising:
when the MO side is not under CS domain, the voice communication signals between the MO side and the MT side are transmitted with IMS bearer between the first MGW and the second MGW.

13. The storage medium of claim 11, further comprising:
when the MT side is not under CS domain, the voice communication signals between the MO side and the MT side are transmitted with IMS bearer between the first MGW and the second MGW.

14. The storage medium of claim 11, wherein the step of determining if the MT side is under CS domain comprises:
generating an invite message according to the setup message, and setting the domain field of the invite message as CS domain;
transmitting the invite message to the visited network, such that a response message is obtained from the visited network; and
determining if the mobile terminating side is under CS domain according to the domain field of the response message.

15. The storage medium of claim 14, wherein the invite message and the response message follow SIP.

16. The storage medium of claim 11, wherein the step of determining if the MO side is under CS domain comprises:
receiving an invite message about the MO side from the originating network; and
determining if the mobile originating side is under CS domain according to the domain field of the invite message.

17. The storage medium of claim 16, wherein the step of determining if the mobile terminating side is under CS domain comprises:
generating and transmitting a setup request to the MT side to obtain a setup response from the MT side; and
determining if the MT side is under CS domain according to the setup response.
